(19) United States
(12) Patent Application Publication
(10) Pub. No.: US 2015/0145266 A1
(43) Pub. Date: May 28, 2015

(54) DOOR LOCK DEVICE

(71) Applicant: Gunhwe Song, Seoul (KR)

(72) Inventor: Gunhwe Song, Seoul (KR)

(73) Assignee: PUSHPULL SYSTEM CO., LTD, Sejong (KR)

(21) Appl. No.: 14/350,211

(22) PCT Filed: Feb. 5, 2014
(86) PCT No.: PCT/KR2014/000987

§ 371 Date: Apr. 7, 2014

(30) Foreign Application Priority Data
Feb. 8, 2013 (KR) 10-2013-0014225

(51) Int. Cl. E05B 1/00

(52) U.S. Cl. CPC E05B 1/0038
USPC 292/336.3

(57) ABSTRACT

A door lock device including a housing coupled to a predetermined portion of the door and having first penetrating holes formed in centers of both lateral sides, respectively, corresponding to front and rear surfaces of the door. A second penetrating hole formed in a wall of the housing. A body unit in the first penetrating hole to reciprocate forward and backward. A hinge traverse a longitudinal center of the body unit. A third penetrating hole is formed in a center of a bottom surface of the body unit. A door lock unit in the housing and body unit. Triangle-shaped holes are formed in both walls of the door lock unit. The door lock unit operating a latch for fixing the door while reciprocated the second penetrating hole and the third penetrating hole by the hinge along the reciprocating movement of the body unit.

### BACKGROUND OF THE DISCLOSURE

1. Field of the Disclosure

Embodiments of the disclosure relates to a door lock device.

2. Discussion of the Related Art

Generally, a door lock device has internal and external handle units installed in both opposite sides of a door, respectively, for a user to rotate in one direction, with holding indoor and outdoor. The user operates the door lock device along the rotation of the handle units to lock and unlock the door.

In addition, a door lock button is installed in a center of a longitudinal end possessed by the internal handle unit to stop the rotation of the external handle unit, so as to prevent the external handle unit from moving from outdoor to indoor. To unlock the door lock button, the internal handle unit may be rotated in one direction or a key cylinder installed in the external handle unit is insertedly rotated.

However, a conventional door lock device is typically rotated in one direction to open and close a door. Accordingly, it is difficult for a user holding something, a child, a patient or a disable to rotate such a conventional door lock device.

### CITED REFERENCE

### Patented Application

(Cited reference 1) KR0378754

### SUMMARY OF THE DISCLOSURE

### Technical Problem

To solve the problems, an object of the disclosure is to provide a door lock device which can open and close a door only by pushing or pulling a door handle, without rotating a door handle.

Another object of the disclosure is to provide a door lock device which has a simple structure only to cause less damage to components and a low error rate.

### Technical Solution

To achieve these objects and other advantages and in accordance with the purpose of the embodiments, as embodied and broadly described herein, a door lock device includes a housing coupled to a predetermined portion of the door, the housing comprising first penetrating holes formed in centers of both lateral sides of the housing, respectively, corresponding to front and rear surfaces of the door, and a second penetrating hole formed in a wall of the housing; a body unit inserted in the first penetrating hole to reciprocate forward and backward with respect to the door, the body unit comprising a hinge traversing a longitudinal center of the body unit and a third penetrating hole formed in a center of a bottom surface of the body unit; a door lock unit inserted in the housing and the body unit, the door lock unit comprising triangle-shaped holes formed in both walls of the door lock unit, respectively, to insert the hinge therein, such that the door lock unit operates a latch for fixing the door while reciprocated the second penetrating hole and the third penetrating hole by the hinge along the reciprocating movement of the body unit; and handles provided in both longitudinal ends of the body, respectively.

The door lock unit may have a hexahedral shape with open lateral surfaces corresponding to the front and rear surfaces of the door, and the triangle-shaped holes may be formed in both walls of the door lock unit, respectively, and a latch coupling grove may be formed one wall adjacent to the walls in which the triangle-shaped holes are formed to couple the latch thereto.

A vertical angle of the triangle-shaped hole may be more distant from the latch than a base line of the triangle-shaped hole to position the hinge at the vertical angle of the triangle-shaped hole in a locked state, and to position the hinge at a base angle located in a direction of the moving hinge, when the body unit is moved in one direction, to open the latch.

The door lock device may further include a first spring provided in the housing to elastically support the door lock unit toward the latch.

The door lock device may further include an auxiliary returning portion for easing the returning of the body unit to a center position after the body unit is moved in one direction.

The auxiliary returning portion may include partition walls projected from both longitudinal ends of the body unit; and second springs provided in the partition walls and both walls of the housing, respectively, to elastically support the provide elasticity for returning the body unit.

The door lock device may further include a locking unit for penetrating a center of one handle to a center of the other handle to restrict the movement of the body unit.

### Advantageous Effects

The embodiments have following advantageous effects.

First, the door lock device according to the embodiments of the disclosure may allow the user to open a door only by pushing or pulling a door handle simply, without rotating a door handle in one direction.

Second, even a user holding something in both hands or in an emergency caused by a fire, a child, a patient or a disable can open a door, only using some body parts without using the hand directly.

Third, the door lock device according to the embodiments of the disclosure has a simple structure and an easy manufacturing process, such that it may have a relatively low production cost and relatively reduced production hours.

Fourth, the door lock device according to the embodiments of the disclosure has such a simple structure as to reduce a damage rate or an error rate thereof.

### BRIEF DESCRIPTION OF THE DRAWINGS

Arrangements and embodiments may be described in detail with reference to the following drawings in which like reference numerals refer to like elements and wherein:

FIG. 1 is a perspective diagram of a door lock device according to embodiments of the disclosure;

FIG. 2 is a perspective diagram of the door lock device without a handle fixing unit;

FIG. 3 is an exploded perspective diagram of the door lock device according to the embodiments of the disclosure;

FIGS. 4 to 6 are sectional diagrams illustrating an operational state of the door lock device according to the embodiments of the disclosure;

FIG. 7 is a perspective diagram illustrating a door lock device having a locking unit further provided therein;

FIG. 8 is an exploded perspective diagram of the door lock device additionally having the locking unit; and

FIG. 9 is a sectional diagram of the door lock device additionally having the locking unit.

### DESCRIPTION OF SPECIFIC EMBODIMENTS

Hereinafter, exemplary embodiments of the disclosure will be described in detail, referring to the accompanying drawings.

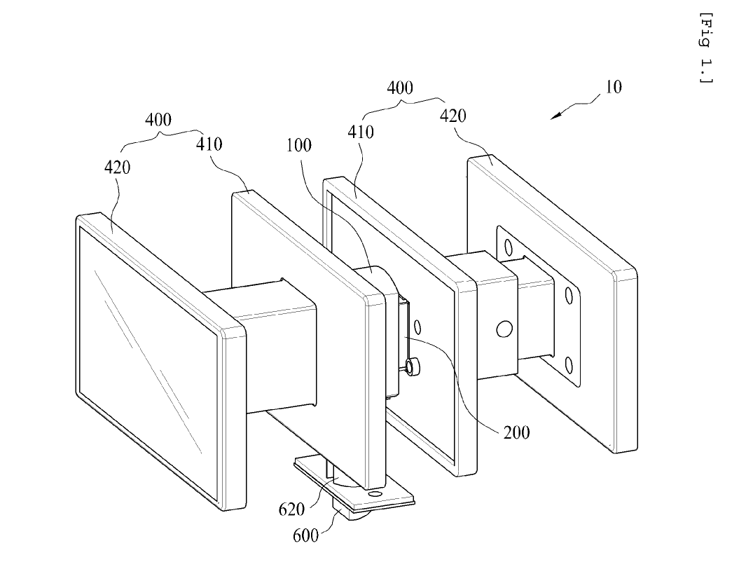

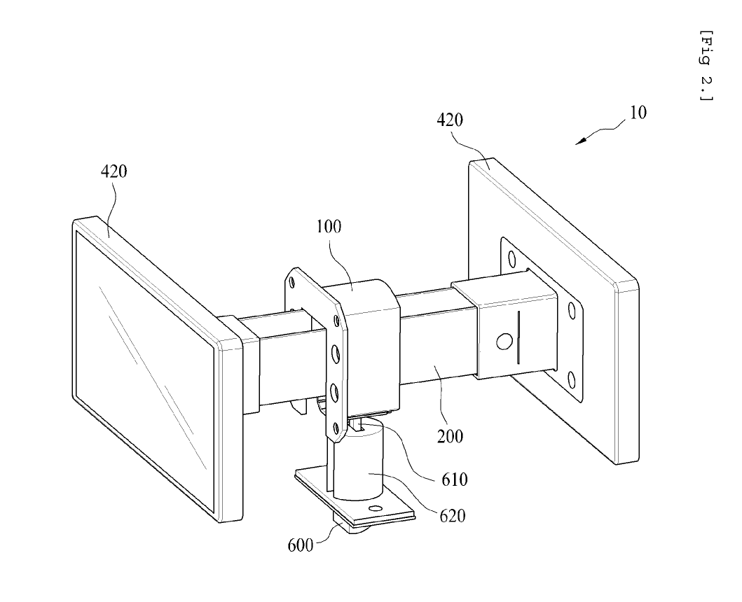

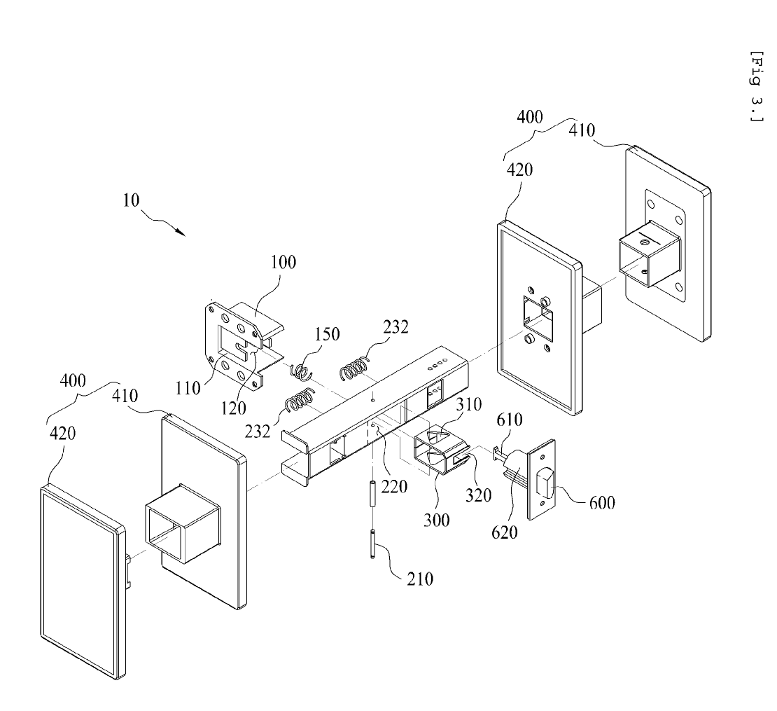

FIG. 1 is a perspective diagram of a door lock device according to embodiments of the disclosure. FIG. 2 is a perspective diagram of the door lock device without a handle fixing unit. FIG. 3 is an exploded perspective diagram of the door lock device according to the embodiments of the disclosure. The door lock device 10 according to exemplary embodiments of the disclosure includes a housing 100, a body unit 200, a door lock unit 300 and a pair of handles 400.

The drawings disclosed herewith illustrate the door lock unit 300 moving vertically, to make characteristics of the present disclosure understood clearly. Description of the door lock unit 300 is made, fitted to the drawings herewith. The door lock unit 300 moves along a lateral surface of a door actually.

The housing 100 may be provided in a predetermined portion of the door. It is preferred that the housing 100 is provided in a portion where a handle 400 is provided to open and close the door 100. Typically, a hole is formed in the door to couple the handle 400 thereto and the housing 100 is insertedly provided in the hole of the door. Such the housing 100 is configured to guide a vertical movement of the door lock unit 300 and a horizontal movement of the body unit 200.

A first penetrating hole 110 formed in a corresponding shape to the body unit 200 is provided in a central portion of each side of the housing 100 to penetrate the body unit 200. At this time, the first penetrating hole 110 has a center concave like a longitudinal cross section area of the body unit 200. A second penetrating hole 120 is formed adjacent to a wall of the housing to allow the door lock unit 300 to rise there along. It is preferred that the second penetrating hole 120 is formed in a bottom surface of the housing 110.

At this time, the second penetrating hole 120 is corresponding to a horizontal cross sectional area of the door lock unit 300 to ease the coupling and moving of the door lock unit 300 or to open the overall bottom surface of the housing 100.

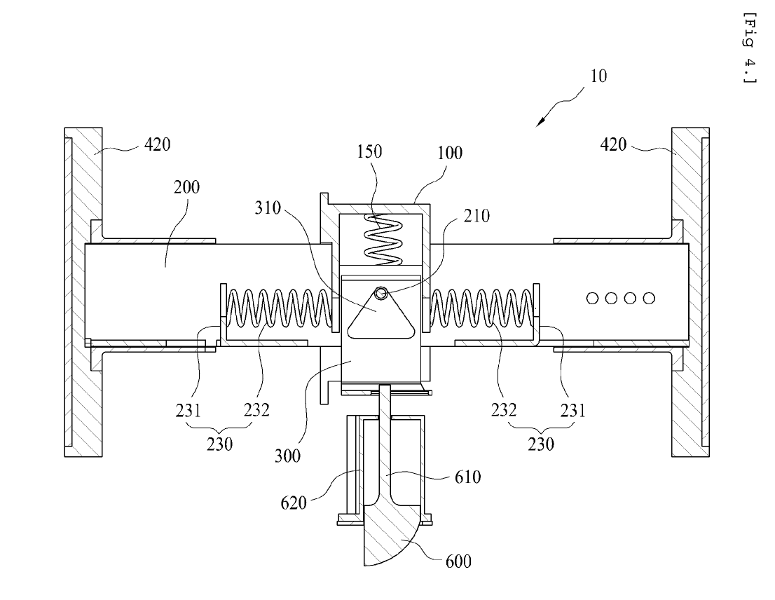

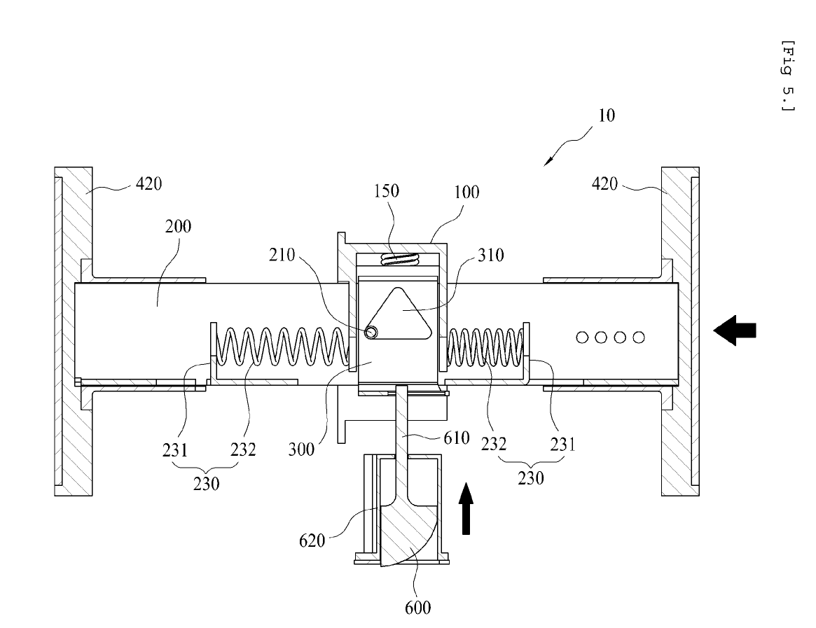

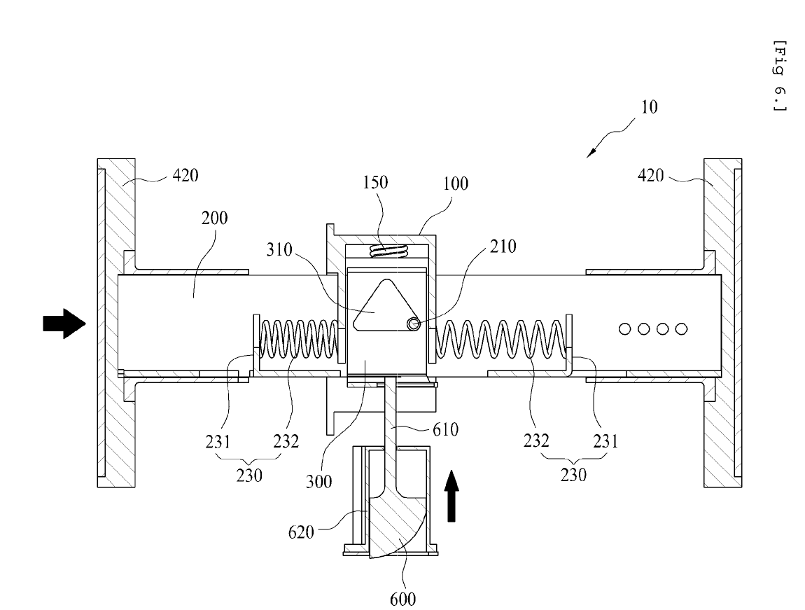

FIGS. 4 to 6 are sectional diagrams illustrating an operational state of the door lock device according to the embodiments of the disclosure. The body unit 200 is inserted in the first penetrating hole 110. Predetermined portions of both longitudinal ends possessed by the body unit 200 are projected a preset distance to front and rear surfaces of the door. The pair of the handles 400 may be provided in both longitudinal ends of the body unit 200, respectively. Such the body unit 200 is configured to operate the door lock unit 300, while reciprocating to the front or rear surface of the door along a longitudinal direction along the operation of the handle 400.

The body unit 200 has a concave longitudinal cross section to be inserted in the first penetrating hole 110. A hinge 210 is provided in a predetermined portion of a longitudinal direction of the body unit 200 and the hinge 210 traverses both walls, adjacent to a longitudinal center of the body unit 200. The third penetrating hole 220 is formed adjacent to a center of the bottom surface of the body unit 200 and the door lock unit 300 may move vertically along the third penetrating hole 220.

At this time, the third penetrating hole 220 has to reciprocate, with the door lock unit 300 inserted therein. Accordingly, the third penetrating hole 220 is relatively longer than the door lock unit 300 to prevent collision between the door lock unit 300 and the third penetrating hole, when the body unit 200 is reciprocating. The hinge 210 may penetrate a triangle-shaped hole 310 formed in the door lock unit 300 after the door lock unit 300 is inserted.

An auxiliary returning portion 230 for returning the moved body unit 200 to the front or rear surface of the door in one direction to the center of the door easily may be provided adjacent to the body unit 200. The auxiliary returning portion 230 may consist of a partition wall 231 and a second spring 232.

A pair of partition walls 231 may be projected inwardly from both longitudinal ends of the body unit 200, respectively. The pair of the partition walls 231 may be projected the same distance from the hinge 210. Second springs 232 may be provided between one wall surface of the housing 100 and one of the partition walls 231 and the other wall surface and the other partition wall 231, respectively.

When the body unit 200 is moved in one direction, the door lock unit 300 rises to make a latch 600 open and the second spring 231 provided in opposite to the open latch is pressed. After that, the force moving the body unit 200 in one direction is removed and the body unit 200 is returned to an original position, in other words, the center of the door by the elasticity of the second spring 232 easily. Accordingly, the door lock unit 300 descends and the latch 600 is projected outside a latch cylinder 620 to be in a locked state.

The door lock unit 300 is inserted in the housing 100 and the body unit 200, so as to operate the latch 600 while moving vertically along the movement of the body unit 200. Such the door lock unit 300 may be formed in a hexahedral shape with open front and rear sides corresponding to front and back sides of the door. Triangle-shaped penetrating holes 310 are formed in both walls of the door lock unit 300 to insert the hinge 210 of the body unit 200 therein. A latch coupling groove 320 is formed in the bottom surface of the door lock unit 300 and an operating hinge 610 of the latch is coupled to the latch coupling groove 320.

At this time, the door lock unit 300 has a predetermined size corresponding to internal widths of the housing 100 and the body unit 200. The size of the door lock unit 300 is determined to reduce the shaking generated by the vertical movement.

The coupling process of the door lock unit 300 will be described hereinafter.

First of all, the door lock unit 300 is inserted in the housing 100.

Hence, the body unit 200 is inserted to penetrate the door lock unit 300 and the housing 100.

The hinge 210 is inserted in the triangle-shaped penetrating hole 310 formed in the door lock unit 300, to fix the door lock unit 300.

The triangle-shape of the hole 310 may an isosceles triangle or an equilateral triangle. A vertical angle of the triangle-shaped hole 310 is sided upward to be more distant from the latch 600 than a bottom side of the triangle-shaped hole 310. Also, vertices of the triangle-shaped hole 310 are rounded at a corresponding angle to an outer circumferential surface of the hinge 210, such that the hinge 210 can be in surface-contact with the vertices of the triangle-shaped hole 310. The surface-contact prevents an impact load to reduce a shock applied to the hinge 210.

A first spring 150 is provided between an upper surface of the door lock unit 300 and an upper surface of the housing 100 to elastically support the door lock unit 300. The door lock unit 300 is normally moved downward to the latch 600 by the elasticity of the first spring 150. The hinge 210 is positioned in the vertices of the triangle-shaped hole 310. In other words, the latch 600 maintains a locked state, projected a preset distance outside the latch cylinder 620.

When the user moves the body unit 200 in one direction in that state, the hinge 210 moves together in the direction toward one base angle of the triangle-shaped hole 310 to move the door lock unit 300 upward. As the door lock unit 300 moves upward, the latch operating hinge 610 coupled to the latch coupling groove 320 of the door lock unit 300 moves upward together. In other words, the latch 600 is inserted in the latch cylinder 620 to be in an unlocked state.

When the force applied by the user is removed, the first spring elastically support the door lock unit 300 downward and the door lock unit 300 moves downward. Accordingly, the hinge 210 moves to a vertical angle along the triangle-shaped hole 310. The latch 600 is projected outside the latch cylinder 620 to return to a locked state. At this time, the elasticity of the second spring 232 mentioned hereinabove may ease the returning of the door lock unit 300 smoothly.

The handles 400 are provided in both longitudinal ends of the body unit 200, respectively, to transmit a force the user uses in operating the body unit 200. Such the handle 400 shown in FIG. 1 includes a fixing portion 410 attached to both lateral sides of the door and an operating unit 420 coupled to both longitudinal ends of the body unit 200 to operate the body unit 200.

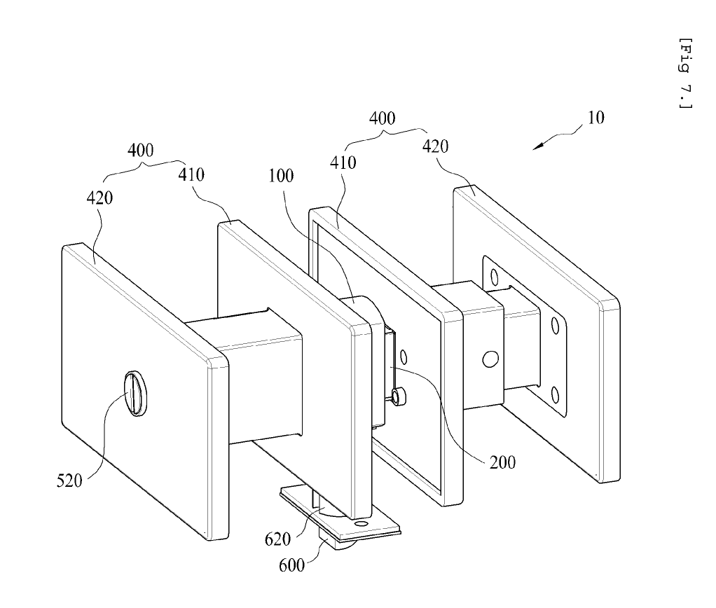

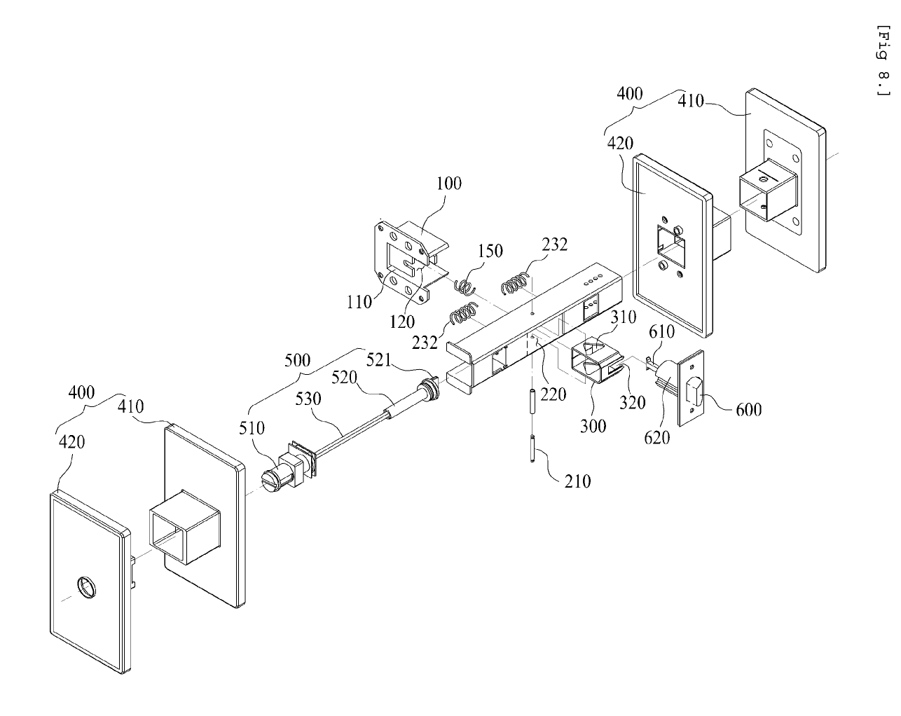

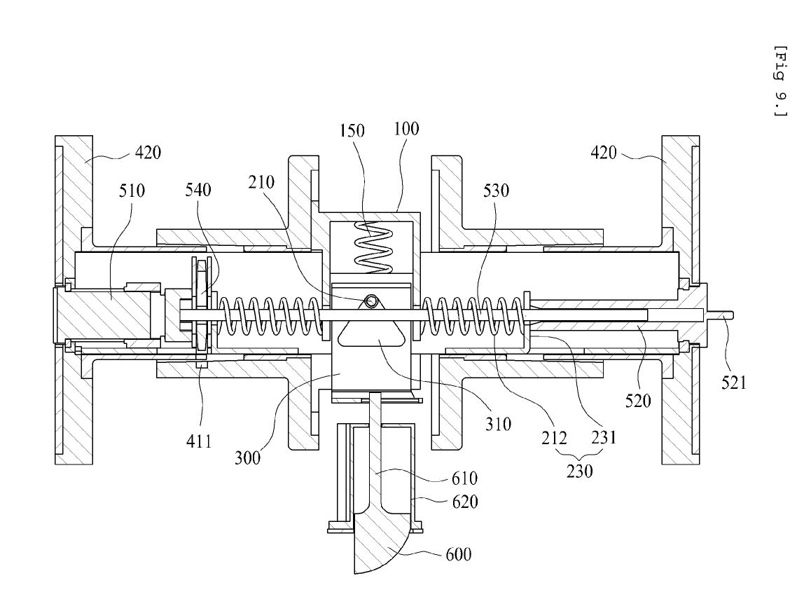

FIG. 7 is a perspective diagram illustrating a door lock device having a locking unit further provided therein. FIG. 8 is an exploded perspective diagram of the door lock device additionally having the locking unit. FIG. 9 is a sectional diagram of the door lock device additionally having the locking unit. The door lock device 10 according to the exemplary embodiments of the disclosure may include a locking unit 500 based on a usage state thereof. When no auxiliary locking is necessary in a hospital or a counseling office, a door need not locking and the locking unit 500 may not be provided. However, a door of a toilet or bathroom or a personal office needs locking and the locking unit 500 is provided in the door.

Such the locking unit 500 is configured to lock and unlock the door lock device 10. The locking unit 500 includes an internal key body 520 provided in the operating units 420 of the handles 400 to be operated by the user with the hand and an external key body 510 operated by a key. The internal key body 520 and the external key body 510. The internal and external key bodies 520 and 510 are connected with each other through a supporting bar 530. At this time, a locking clasp 540 is formed in the supporting bar 530 and a clasp groove 411 is formed in the fixing portion 410 of the handle 400 to latch the locking clasp 540 thereon, corresponding to the locking clasp 540.

The supporting bar 530 is connected from one handle 400 to the other handle 400 through the supporting bar 530. For that, penetrating holes are formed in the pair of the partition walls 231 and front and rear surfaces of the housing 100, respectively. The locking unit 500 having the structure is normally unlocked. However, when the user rotates locking means 521 of the internal key body 520 or the key, the locking clasp 540 is rotated and the rotating locking clasp 540 is inserted in the clasp groove 411, such that the operation of the door lock device 10 is restricted. In that state, the door will not open even when the user pushes or pulls the both handles 400 in one direction.

Otherwise, when the key or the locking means 521 is rotated to its original position, the locking clasp 540 is unlatched out of the locking groove 411. Once the locking clasp 540 is latched out of the locking groove 410, the body unit 200 can move freely to open and close the door.

The locking unit 500 applied to the door lock device according to the disclosure are described to have the structure mentioned hereinabove. The locking unit 500 having the structure configured to achieve the purpose may be used.

Various variations and modifications of the refrigerator described above are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A door lock device comprising:
a housing coupled to a predetermined portion of the door, the housing comprising first penetrating holes formed in centers of both lateral sides of the housing, respectively, corresponding to front and rear surfaces of the door, and a second penetrating hole formed in a wall of the housing;
a body unit inserted in the first penetrating hole to reciprocate forward and backward with respect to the door, the body unit comprising a hinge traversing a longitudinal center of the body unit and a third penetrating hole formed in a center of a bottom surface of the body unit;
a door lock unit inserted in the housing and the body unit, the door lock unit comprising triangle-shaped holes formed in both walls of the door lock unit, respectively, to insert the hinge therein, such that the door lock unit operates a latch for fixing the door while reciprocated the second penetrating hole and the third penetrating hole by the hinge along the reciprocating movement of the body unit; and
handles provided in both longitudinal ends of the body, respectively.

2. The door lock device of claim 1, wherein the door lock unit has a hexahedral shape with open lateral surfaces corresponding to the front and rear surfaces of the door, and the triangle-shaped holes are formed in both walls of the door lock unit, respectively, and
a latch coupling grove is formed one wall adjacent to the walls in which the triangle-shaped holes are formed to couple the latch thereto.

3. The door lock device of claim 1, wherein a vertical angle of the triangle-shaped hole is more distant from the latch than a base line of the triangle-shaped hole to position the hinge at the vertical angle of the triangle-shaped hole in a locked state, and to position the hinge at a base angle located in a direction of the moving hinge, when the body unit is moved in one direction, to open the latch.

4. The door lock device of claim 1, further comprising:
a first spring provided in the housing to elastically support the door lock unit toward the latch.

5. The door lock device of claim 1, further comprising:
an auxiliary returning portion for easing the returning of the body unit to a center position after the body unit is moved in one direction.

6. The door lock device of claim 5, wherein the auxiliary returning portion comprises,
partition walls projected from both longitudinal ends of the body unit; and
second springs provided in the partition walls and both walls of the housing, respectively, to elastically support the provide elasticity for returning the body unit.

7. The door lock device of claim 1, further comprising:
a locking unit for penetrating from a center of one handle to a center of the other handle to restrict the movement of the body unit.
